(19) United States
(12) Patent Application Publication
(10) Pub. No.: US 2024/0291163 A1
(43) Pub. Date: Aug. 29, 2024

(54) HOLOGRAPHIC LEAKY-WAVE ANTENNA AND ELECTRONIC DEVICE

(71) Applicant: BOE Technology Group Co., Ltd., Beijing (CN)

(72) Inventors: Yiqun HU, Beijing (CN); Jia FANG, Beijing (CN); Zongmin LIU, Beijing (CN); Feng QU, Beijing (CN)

(21) Appl. No.: 18/290,781

(22) PCT Filed: Feb. 28, 2023
(86) PCT No.: PCT/CN2023/078687

§ 371 Date: Jan. 21, 2024

(51) Int. Cl. H01Q 13/28; H01Q 1/50; H01Q 17/00

(52) U.S. Cl. CPC H01Q 13/28; H01Q 1/50; H01Q 17/00

(57) ABSTRACT

A holographic leaky-wave antenna includes a first waveguide structure, a first dielectric substrate, a radiation layer, and a first reference electrode layer. The first dielectric substrate is arranged on the first waveguide structure and has a first gap with the waveguide structure. The first reference electrode layer is arranged on a side of the first waveguide structure distal to the first dielectric substrate. The radiation layer is arranged on a side of the first dielectric substrate distal to the first waveguide structure, and has a plurality of slit openings therein. The holographic leaky-wave antenna further comprises a plurality of feeding ports configured on the first waveguide structure, and an orthogonal projection of each of the plurality of feeding ports on the first dielectric substrate does not overlap with an orthogonal projection of the first reference electrode layer on the first dielectric substrate.

### CROSS-REFERENCE TO RELATED APPLICATIONS

This is a National Phase Application filed under 35 U.S.C. 371 as a national stage of PCT/CN2023/078687 filed on Feb. 28, 2023, the entire content of which is incorporated herein by reference.

### TECHNICAL FIELD

The present disclosure relates to the field of communication technology, and in particular, relates to a holographic leaky-wave antenna and an electronic device.

### BACKGROUND

A liquid crystal holographic electronically controlled scanning array antenna is a low-profile and low-cost antenna capable of beamforming (i.e., beamformable antenna) implemented by applying holographic control theory to a liquid crystal electronically controlled scanning antenna. The holographic technology is a technology which records amplitude information and phase information of an object by using the principles related to interference and diffraction of waves and by reproducing a three-dimensional image of the object. A holographic antenna is an application of the holographic technology in the field of microwave engineering, and can acquire a desired radiation electromagnetic wave by recording and recovering an interference field of a reference electromagnetic wave and a desired radiation electromagnetic wave. The holographic antenna generally has two parts, which are a feeding structure and a holographic structure. The feeding structure is configured to transmit a reference wave which can mutually interfere with the desired radiation electromagnetic wave, and the holographic structure is configured to record the distribution of an interference field. When the holographic antenna operates, the interference field is firstly formed on a certain plane by the reference electromagnetic wave and the desired radiation electromagnetic wave, then the distribution of the interference field is recorded by the holographic structure, and finally the holographic structure recorded with the distribution of the interference field is excited by the reference electromagnetic wave, thereby recovering (or reproducing) the desired radiation electromagnetic wave. In a case where an antenna unit has the characteristic of controllable radiation electromagnetic waves, a liquid crystal holographic electronically controlled scanning antenna can dynamically record various interference field distribution conditions, thereby recovering (or reproducing) the desired radiation electromagnetic wave and achieving beamformable properties.

### SUMMARY

Embodiments of the present disclosure provide a holographic leaky-wave antenna and an electronic device.

In a first aspect, embodiments of the present disclosure provide a holographic leaky-wave antenna, which includes a first waveguide structure,
a first dielectric substrate,
a radiation layer, and
a first reference electrode layer,
wherein the first dielectric substrate is arranged on the first waveguide structure and has a first gap with the first waveguide structure;
the first reference electrode layer is arranged on a side of the first waveguide structure distal to the first dielectric substrate;
the radiation layer is arranged on a side of the first dielectric substrate distal to the first waveguide structure, and has a plurality of slit openings therein; and
the holographic leaky-wave antenna further includes a plurality of feeding ports configured on the first waveguide structure, and an orthogonal projection of each of the plurality of feeding ports on the first dielectric substrate does not overlap with an orthogonal projection of the first reference electrode layer on the first dielectric substrate.

In an embodiment, the holographic leaky-wave antenna further includes a feeding structure configured to excite a microwave signal through the plurality of feeding ports.

In an embodiment, the feeding structure includes a plurality of coaxial probes, each of which is installed at a position of one of the feeding ports.

In an embodiment, the feeding structure includes SMA interfaces, each of which is installed at a position of one of the feeding ports.

In an embodiment, the plurality of feeding ports include four feeding ports.

In an embodiment, the plurality of feeding ports include four feeding ports which are a first feeding port, a second feeding port, a third feeding port, and a fourth feeding port, a connection line between a center of the first feeding port and a center of the second feeding port is a first line segment, a connection line between a center of the third feeding port and a center of the fourth feeding port is a second line segment, and the first line segment and the second line segment are perpendicular to each other.

In an embodiment, the center of first feeding port, the center of the second feeding port, the center of the third feeding port and the center of the fourth feeding port each have a same distance, which is a first distance, from a center of the first waveguide structure.

In an embodiment, the first distance ranges from 3 mm to 8 mm.

In an embodiment, the first waveguide structure includes a slow-wave dielectric layer having the first gap with the first dielectric substrate.

In an embodiment, the holographic leaky-wave antenna further includes a supporting member, wherein both ends of the supporting member abut against the slow-wave dielectric layer and the first dielectric substrate, respectively.

In an embodiment, the first gap has a thickness of 1.0 mm to 1.4 mm.

In an embodiment, the holographic leaky-wave antenna further includes a second waveguide structure disposed on a side of the radiation layer proximal to the first waveguide structure, and a second reference electrode layer disposed on a side of the second waveguide structure proximal to the first waveguide structure.

In an embodiment, the holographic leaky-wave antenna further includes an absorbing load disposed in the second waveguide structure.

In an embodiment, the holographic leaky-wave antenna further includes a wave absorbing structure provided at a peripheral region of the first waveguide structure.

In an embodiment, the holographic leaky-wave antenna further includes switching units provided on a side of the radiation layer distal to the first dielectric substrate, wherein the switching units are in one-to-one correspondence with the slit openings.

In an embodiment, each of the switching units includes any one of a PIN diode, a variable reactance diode, a liquid crystal switch, or a MEMS switch.

In an embodiment, each of the slit openings has a length of 0.1 λg to 0.4 λg and a width of 0.001 λg to 0.04λg, where λg is a wavelength of a wave in the first waveguide structure.

In an embodiment, the plurality of slit openings are arranged in an array or in a spiral shape.

In an embodiment, an outline of the radiation layer includes a rectangle or a circle.

In a second aspect, an embodiment of the present disclosure provides an electronic device, which includes the holographic leaky-wave antenna according to any one of the embodiments of the first aspect.

### BRIEF DESCRIPTION OF THE DRAWINGS

FIG. 1 is a schematic cross-sectional view of a holographic leaky-wave antenna according to an embodiment of the present disclosure.

FIG. 2 is a schematic top view of the holographic leaky-wave antenna shown in FIG. 1 corresponding to a beam pointing of 0°.

FIG. 3 is a schematic top view of the holographic leaky-wave antenna shown in FIG. 1 corresponding to a beam pointing of 30°.

FIG. 4 is a schematic top view of the holographic leaky-wave antenna shown in FIG. 1 corresponding to a beam pointing of 60°.

FIG. 5 is a schematic cross-sectional view of another holographic leaky-wave antenna according to an embodiment of the present disclosure.

FIG. 6 is a schematic top view of the holographic leaky-wave antenna shown in FIG. 5.

FIG. 7 is a schematic diagram of a part of switching units of a first example according to an embodiment of the present disclosure.

FIG. 8 is a partial schematic diagram of a switching unit of a second example according to an embodiment of the present disclosure.

FIG. 9 is a partial schematic diagram of a switching unit of a third example according to an embodiment of the present disclosure.

FIG. 10 is another schematic top view of the holographic leaky-wave antenna shown in FIG. 5.

FIG. 11 is an actual topology diagram of a holographic leaky-wave antenna according to an embodiment of the present disclosure after binarization in a case of a beam pointing of φ₀=90° and θ₀=0°.

FIG. 12 is an actual topology diagram of a holographic leaky-wave antenna according to an embodiment of the present disclosure after binarization in a case of a beam pointing of φ₀=90° and θ₀=30°.

FIG. 13 is an actual topology diagram of a holographic leaky-wave antenna according to an embodiment of the present disclosure after binarization in a case of a beam pointing of φ₀=90° and θ₀=60°.

FIG. 14a is a schematic directional pattern of a single point feeding in a case of a beam pointing of 0°.

FIG. 14b is a schematic directional pattern of a four-point feeding in a case of a beam pointing of 0°.

FIG. 15a is a schematic directional pattern of a single point feeding in a case of a beam pointing of 30°.

FIG. 15b is a schematic directional pattern of a four-point feeding in a case of a beam pointing of 30°.

FIG. 16a is a schematic directional pattern of a single point feeding in a case of a beam pointing of 60°.

FIG. 16b is a schematic directional pattern of a four-point feeding in a case of a beam pointing of 60°.

FIG. 17 is a schematic normalized 2D directional pattern with poor sidelobes for a single point feeding and a four-point feeding in a case of a beam pointing of 0°.

FIG. 18 is a schematic normalized 2D directional pattern with poor sidelobes for a single point feeding and a four-point feeding in a case of a beam pointing of 30°.

FIG. 19 is a schematic normalized 2D directional pattern with poor sidelobes for a single point feeding and a four-point feeding in a case of a beam pointing of 60°.

FIG. 20 is a schematic diagram illustrating that a Z-axis is adjusted to be at the same angle as a radiation angle of an antenna.

FIG. 21 is a schematic directional pattern of a middle depression of an equal-amplitude 90° phase-difference feeding achieved by a holographic leaky-wave antenna according to an embodiment of the present disclosure.

FIG. 22 is a schematic cross-sectional view of another holographic leaky-wave antenna according to an embodiment of the present disclosure.

### DETAILED DESCRIPTION OF EMBODIMENTS

To make technical solutions of the present disclosure be better understood by one of ordinary skill in the art, the present disclosure will be further described below in detail with reference to the accompanying drawings and exemplary embodiments.

Unless defined otherwise, technical or scientific terms used herein shall have the ordinary meaning as understood by one of ordinary skill in the art to which this disclosure belongs. The terms of “first”, “second”, and the like used in this disclosure are not intended to indicate any order, quantity, or importance, but rather are used for distinguishing one element from another. Further, the use of the term “a”, “an”, “the”, or the like does not denote a limitation of quantity, but rather denotes the presence of at least one. The term of “comprising”, “including”, or the like, means that the element or item preceding the term contains the element or item listed after the term and its equivalent, but does not exclude the presence of other elements or items. The term “connected”, “coupled”, or the like is not limited to physical or mechanical connections, but may include electrical connections, whether direct or indirect. The terms “upper”, “lower”, “left”, “right”, and the like are used only for indicating relative positional relationships, and when the absolute position of an object being described is changed, the relative positional relationships may also be changed accordingly.

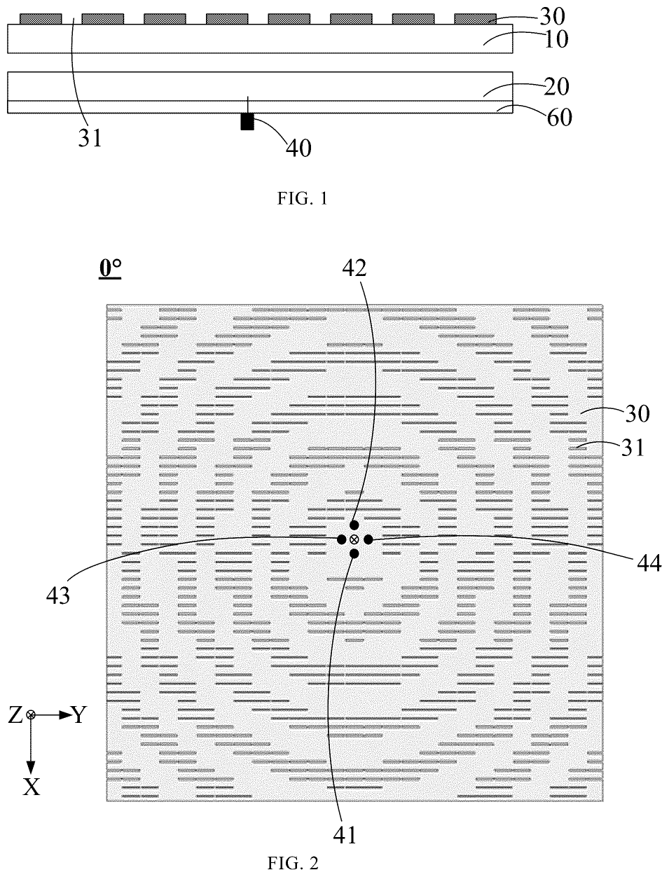

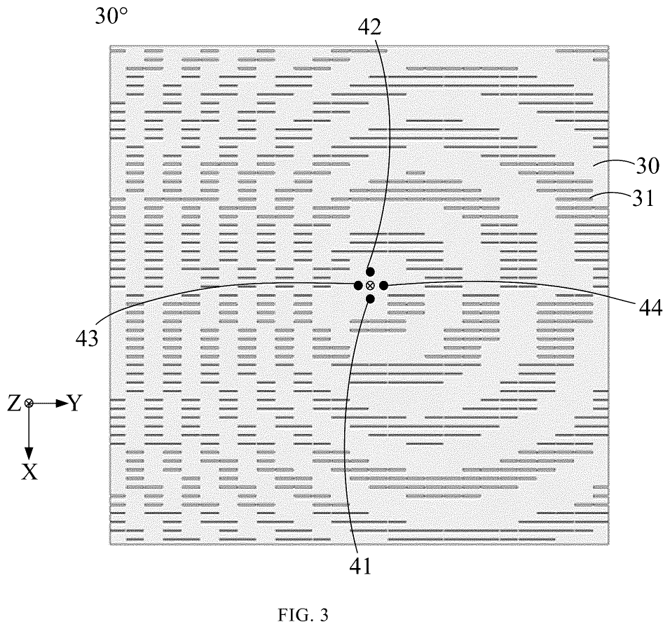

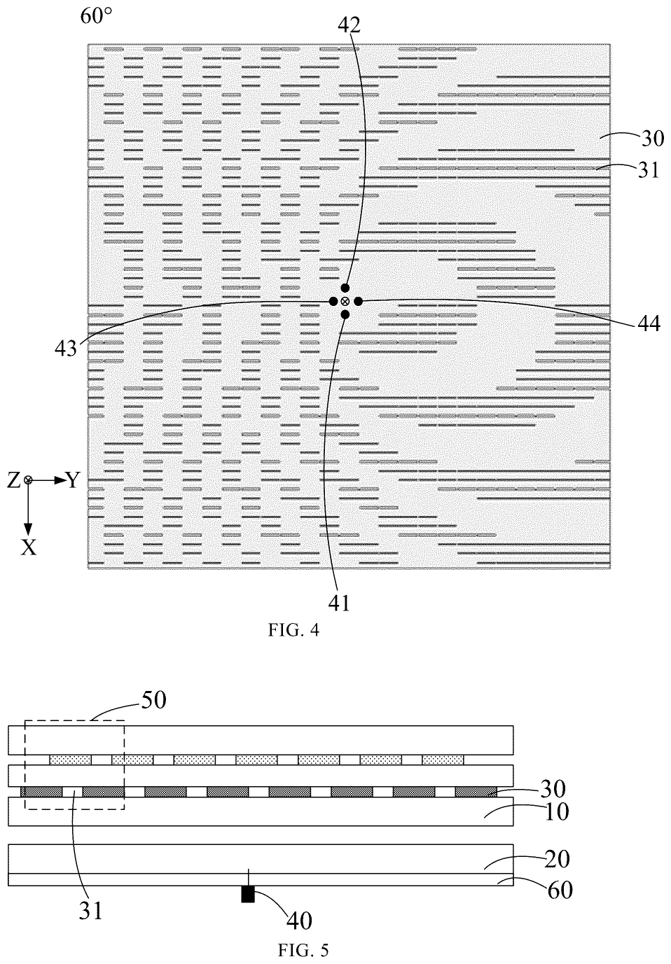

In a first aspect, FIG. 1 is a schematic cross-sectional view of a holographic leaky-wave antenna according to an embodiment of the present disclosure. FIG. 2 is a schematic top view of the holographic leaky-wave antenna shown in FIG. 1 corresponding to a beam pointing of 0°. FIG. 3 is a schematic top view of the holographic leaky-wave antenna shown in FIG. 1 corresponding to a beam pointing of 30°. FIG. 4 is a schematic top view of the holographic leaky-wave antenna shown in FIG. 1 corresponding to a beam pointing of 60°. As shown in FIGS. 1-4, the holographic leaky-wave antenna provided by the present embodiment includes a first waveguide structure 20, a first dielectric substrate 10, a radiation layer 30, and a first reference electrode layer 60. The first dielectric substrate 10 is disposed on the first waveguide structure 20, and a first gap is formed between the first dielectric substrate 10 and the first waveguide structure 20. The first reference electrode layer 60 is disposed on a side of the first waveguide structure 20 distal to the first dielectric substrate 10. The radiation layer 30 is disposed on a side of the first dielectric substrate 10 distal to the first waveguide structure 20, and has a plurality of slit openings 31 therein. In particular, the holographic antenna according to the present embodiment is configured with a plurality of feeding ports 40, and an orthogonal projection of each of the plurality of feeding ports 40 on the first dielectric substrate 10 does not overlap with an orthogonal projection of the first reference electrode layer 60 on the first dielectric substrate 10. That is, in the present embodiment, multi-point feeding is adopted, and compared with single-point feeding, the multi-point feeding can achieve better radiation without a wave absorbing material, and has better anti-echo interference capability.

It should be noted that in the following examples of the present disclosure, an example is taken in which the holographic leaky-wave antenna is configured with only four feeding ports 40, i.e., the holographic leaky-wave antenna operates in a mode of four-point feeding, and for convenience of description, the four feeding ports 40 are respectively referred to as a first feeding port 41, a second feeding port 42, a third feeding port 43, and a fourth feeding port 44. However, the holographic leaky-wave antenna according to the present embodiment is not limited to adopting the four-point feeding, and may be any integer which is greater than 1 and divides 360 exactly (i.e., divides 360 with a remainder of zero), for example, three-point feeding, six-point feeding, or the like may alternatively be adopted.

In some examples, the first waveguide structure 20 according to the present embodiment includes a slow-wave dielectric layer. For example, the first waveguide structure 20 includes a waveguide cavity, and a low-loss polymer material may be filled in the waveguide cavity to serve as the slow-wave dielectric layer, so as to achieve the effect of slow-wave waveguide.

Further, the first gap between the first waveguide structure 20 and the first dielectric substrate 10 may be an air gap. That is, the air gap is formed between the first dielectric substrate 10 and the slow-wave dielectric layer. In order to form the air gap between the first dielectric substrate 10 and the slow-wave dielectric layer, a supporting member may be disposed between the first dielectric substrate 10 and the slow-wave dielectric layer, and both ends of the supporting member abut against the first dielectric substrate 10 and the slow-wave dielectric layer, respectively. In some examples, the supporting member may be a nylon pillar or the like.

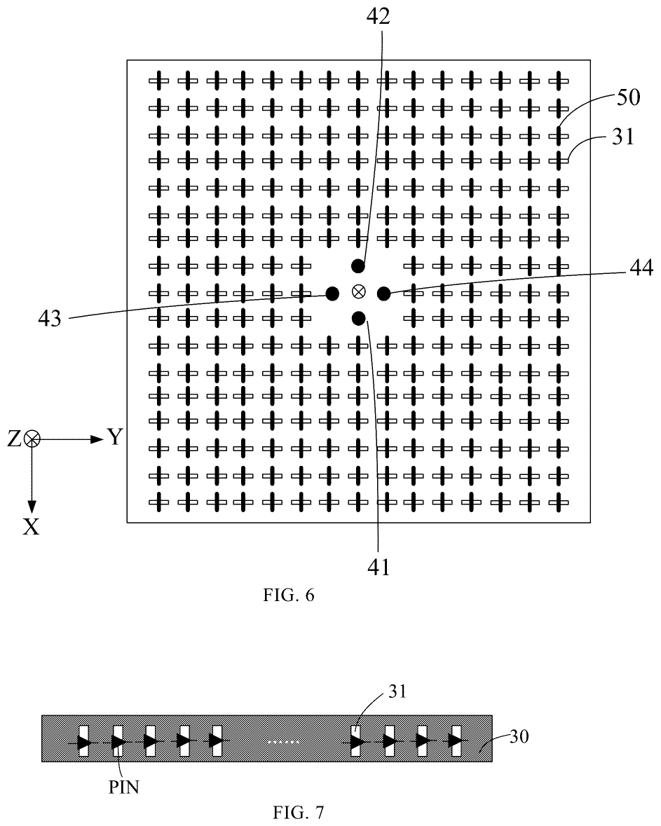

In some examples, FIG. 5 is a schematic cross-sectional view of another holographic leaky-wave antenna according to an embodiment of the present disclosure, and FIG. 6 is a schematic top view of the holographic leaky-wave antenna shown in FIG. 5. As shown in FIGS. 5 and 6, the holographic leaky-wave antenna according to the present embodiment includes not only the above-described structures but also switching units 50 corresponding to the slit openings 31. For example, the switching units 50 are disposed on a side of the radiation layer 30 distal to the first dielectric substrate, and are in one-to-one correspondence with the slit openings 31. Each switching unit 50 is configured to control whether the slit opening 31 corresponding to the switching unit 50 can feed out a radio frequency signal. A switching state of the slit opening 31 may be controlled by a switching state of the corresponding switching unit 50 according to a beam direction. FIG. 7 is a schematic diagram of a part of the switching units 50 of a first example according to an embodiment of the present disclosure. As shown in FIG. 7, each switching unit 50 may be a PIN diode or a variable reactance diode (e.g., a varactor). In this case, the PIN diode or the variable reactance diode (e.g., the varactor) may be integrated with the corresponding slit opening 31, thereby achieving a regulation capability of binary amplitude or continuous amplitude. For example, taking the example that each switching unit 50 is the PIN diode, the input of a bias voltage to the PIN diode is controlled, thereby controlling the forward/reverse bias of the PIN diode. When a slit opening 31 is required to be in an open state, the bias voltage input to the corresponding PIN diode is greater than a turn-on threshold value of the corresponding PIN diode, and the corresponding PIN diode is turned on. When the slit opening 31 is required to be in a closed state, the corresponding PIN diode is input with a bias voltage smaller than its turn-on threshold value, and the corresponding PIN diode is turned off.

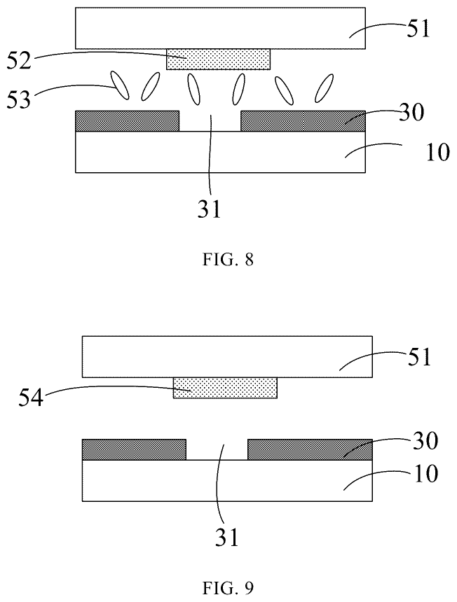

FIG. 8 is a partial schematic diagram of a switching unit 50 of a second example according to an embodiment of the present disclosure. As shown in FIG. 8, the switching unit 50 is a liquid crystal switch, that is, a second dielectric substrate 51 is disposed opposite to the first dielectric substrate 10, a control electrode 52 is disposed on the second dielectric substrate 51, and a liquid crystal layer 53 is disposed between a layer where the control electrode 52 on the second dielectric substrate 51 is located and a layer where a microstrip line is located. By changing a voltage applied to the control electrode 52, a rotation angle of liquid crystal molecules of the liquid crystal layer 53 is changed, thereby realizing continuous control of an amplitude of a radio frequency signal radiated from the slit opening 31.

FIG. 9 is a partial schematic diagram of a switching unit 50 of a third example according to an embodiment of the present disclosure. As shown in FIG. 9, the switching unit 50 is a MEMS switch. For example, a second dielectric substrate 51 is arranged opposite to the first dielectric substrate 10, and the second dielectric substrate 51 is a flexible substrate. Patch electrodes 54 are arranged on the second dielectric substrate 51, and are in one-to-one correspondence with the slit openings 31. In this case, by applying a voltage to the patch electrodes 54, a distance between each patch electrode 54 and the corresponding slit opening 31 is adjusted under the action of an electric field force, so that a radiation amplitude of a radio frequency signal is continuously adjusted and controlled.

For the holographic leaky-wave antenna shown in each of FIGS. 5 and 6, a method for controlling the switching units 50 to be turned on and off during an operation process of the holographic leaky-wave antenna may include the following steps S10 to S30.

Step S10 includes acquiring an excitation amplitude value of each slit opening 31 through an amplitude sampling function according to position information, a target pointing angle and a simulation frequency of the slit opening 31.

In step S10, the position information of the slit opening 31 in the microstrip line of the holographic antenna may be stored in advance, the simulation frequency may be 12 GHz, the target pointing angle may be 0°, ±30°, ±60°, etc., or other angles may be selected. Then, based on the holographic principle and according to the amplitude sampling function, the excitation amplitude value of each slit opening 31 is acquired.

In some examples, prior to step S10, the method may further include a step of acquiring the amplitude sampling function, and the step of acquiring the amplitude sampling function may include the following steps S01 and S02.

Step S01 includes acquiring an interference wave by causing a reference wave and an object wave to interfere with each other.

In step S01, the interference wave may be acquired by multiplying a conjugation of the reference wave by the object wave.

It should be noted that the holographic principle is as follows: an interference pattern is acquired by making the reference wave and the object wave interfere with each other. For example, the object wave is ψ_{obj}(\vec{r}; θ₀, ϕ₀)=exp(−ik_{f}(θ₀, ϕ₀)·\vec{r}), and the reference wave is ψ_{ref}(\vec{r})≈exp(−ikₛ·\vec{r}), where k_{f} is an object wave vector, kₛ is a reference wave vector. The interference pattern information (i.e., the interference wave) is represented as following equations:

$$T ∝ {\vert {ψ}_{obj} + {ψ}_{ref} \vert}^{2} ,$$

$$T {ψ}_{ref} ∝ {\vert {ψ}_{obj} \vert}^{2} {ψ}_{ref} + {ψ}_{obj} {ψ}_{ref}^{2} + {ψ}_{obj} {\vert {ψ}_{ref} \vert}^{2} + {\vert {ψ}_{ref} \vert}^{2} {ψ}_{ref} ,$$

where ψ_{obj}|ψ_{ref}|² is the important interference pattern information of the object wave. It can be known from the equations that when the reference wave interacts with the object wave, specific beam angles (e.g., a horizontal direction angle θ₀, and a beam pointing angle ϕ₀) may be acquired.

Step S02 includes performing calculation on the interference wave according to a preset algorithm to acquire the amplitude sampling function.

Taking a one-dimensional antenna as an example, step S02 may include expanding an e-exponential function of the interference wave by using the Euler equation to acquire a real part (i.e., a cosine function) thereof, and adding amplitude factors such as Xᵢ and Mᵢ thereto to ensure that the amplitude sampling is always positive, thereby acquiring the amplitude sampling function as follows:

$${α}_{m , i} ( ω ) = {X}_{i} + {M}_{i} cos ( β {x}_{i} + k {x}_{i} sin {ϕ}_{0} )$$

where Xᵢ and Mᵢ are amplitude constants, Xᵢ≥Mᵢ, β is a propagation constant of the reference wave, k is a target propagation constant, a target pointing angle is set to be ϕ₀, and xᵢ is a position of a slit opening 31.

Step S20 includes discretizing (i.e., performing a discretization process on) the excitation amplitude value of each slit opening 31 to acquire a discretization result.

In some examples, step S20 may include performing a discretization process (i.e., a binarization process) on the excitation amplitude value of each slit opening 31, with a discretization threshold of t, 0<t<1; if the excitation amplitude value m of a slit opening 31 is not less than t, a discrete result M is acquired as 1, and if the excitation amplitude value m of the slit opening 31 is less than t, the discrete result M is acquired as 0.

For example: t=0.5, the number of the slit openings 31 is 64, the excitation amplitude value m of one slit opening acquired in step S10 is 0.79, and the excitation amplitude value m of another slit opening acquired in step S10 is 0.35. In this case, the discrete result M of the excitation amplitude value m of the one slit opening is recorded as 1, and the discrete result M of the excitation amplitude value m of the another slit opening is recorded as 0. In this way, the discrete results M of the excitation amplitude values m of the 64 slit openings 31 are acquired.

It should be noted that an amplitude of the discretization threshold t needs to be adjusted, a millimeter wave holographic antenna may be acquired according to different discretization thresholds t, and a simulation diagram of the millimeter wave holographic antenna may be acquired by performing simulation on the millimeter wave holographic antenna with an electromagnetic software. By comparing the simulation diagram of the millimeter wave holographic antenna with an amplitude weighted theory simulation diagram of the holographic antenna, the desired discretization threshold t is found out. In this way, when the simulation diagram of the millimeter wave holographic antenna is closest to the amplitude weighted theory simulation diagram of the holographic antenna, the discretization threshold t corresponding to the simulation diagram of the millimeter wave holographic antenna is taken as the desired discretization threshold t.

Step S30 includes controlling on-off states of the switching units 50 according to the discrete results to control open-closed state of the slit openings 31.

Specifically, when the excitation amplitude values m of the slit openings 31 are subjected to the discretization process in step S20 and the discrete results M are recorded as 0 or 1, in step S30, a switching unit 50 is controlled to be in the turn-on state if its discrete result M is 1, so that the corresponding slit opening 31 is in the open state, and a switching unit 50 is controlled to be in the turn-off state if its discrete result M is 0, so that the corresponding slit opening 31 is in the closed state.

In some examples, the holographic leaky-wave antenna according to the present embodiments further includes a feeding structure, and the feeding structure may include a plurality of probes or a plurality of SMA interfaces (which are also referred to as “SMA connectors”). Taking the example that the holographic leaky-wave antenna includes four feeding ports 40 that are the first feeding port 41, the second feeding port 42, the third feeding port 43 and the fourth feeding port 44, the feeding structure includes four probes, which may be coaxial probes. In this case, one of the probes is installed at a position corresponding to each of the first feeding port 41, the second feeding port 42, the third feeding port 43, and the fourth feeding port 44, and each probe is inserted into the slow-wave dielectric layer from the first reference electrode layer 60, so as to excite an electromagnetic wave. Similarly, in the case where the feeding structure includes the plurality of SMA interfaces, one of the probes (i.e., one of the SMA interfaces) is installed at a position corresponding to each of the first feeding port 41, the second feeding port 42, the third feeding port 43 and the fourth feeding port 44, and each probe is inserted into the slow-wave dielectric layer from the first reference electrode layer 60, so as to excite an electromagnetic wave. The feeding ports 40 in the present embodiment perform excitation by the probes or the SMA interfaces, and in this case, a phase shifter may be electrically connected through the probes or the SMA interfaces, equal-amplitude in-phase feeding may be implemented, or unequal-amplitude phase feeding may also be implemented, so that the directional patterns of the antenna are various.

In some examples, the feeding structure in the present embodiment may alternatively adopt a power division feeding network, and in this case, an amplitude and a phase of each feeding port 40 may not be changed, and the antenna may only implement a single directional pattern.

In some examples, the holographic leaky-wave antenna in the present embodiment may include not only the above structures, but also a wave-absorbing structure located in a peripheral region of the first waveguide structure 20. By including the wave-absorbing structure, the antenna can have a directional pattern and a standing wave which are improved to a certain extent.

In some examples, the slit openings 31 in the present embodiment may be arranged in an array or in a spiral shape. The positions of the slit openings 31 may be designed according to a radiation direction of the antenna.

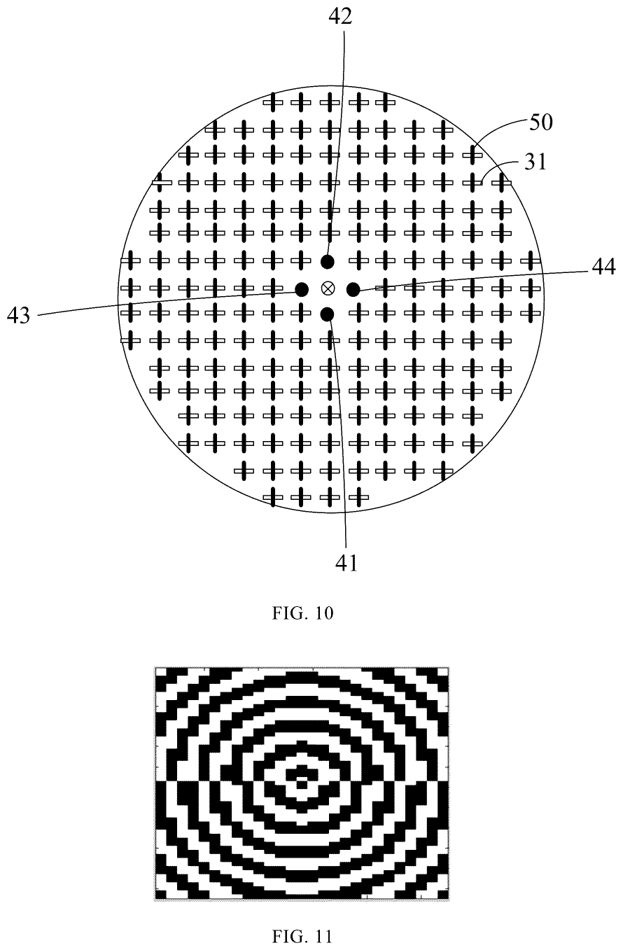

In some examples, an outline of the radiation layer 30 according to an embodiment of the present disclosure may be a rectangle, as shown in each of FIGS. 2-4 and 6. FIG. 10 is another schematic top view of the holographic leaky-wave antenna shown in FIG. 5. As illustrated in FIG. 10, the outline of the radiation layer 30 may alternatively be a circle. The shape of the radiation layer 30 is not limited in an embodiment of the present disclosure.

In some examples, the holographic leaky-wave antenna may adopt any one of the above structures, the radiation layer 30 of the holographic leaky-wave antenna may be a metal grid structure, and the metal grid structure may be formed on a flexible substrate and then attached to the first dielectric substrate 10 through an adhesive layer. A material of the flexible substrate includes, but is not limited to, polyethylene terephthalate (PET), polyimide (PI), copolymers of cycloolefin (COP), or the like. A material of the adhesive layer includes, but is not limited to, optically clear adhesive (OCA).

The holographic leaky-wave antenna has diverse application scenarios, and has important applications in the aspects of satellite communication, mobile communication, imaging, wireless charging, multi-user MIMO (multiple input multiple output), and the like, due to its advantages of beam reconfigurability, multi-beam generation, multi-frequency beam generation, high-gain beam focusing, and the like.

The holographic leaky-wave antenna in an embodiment of the present disclosure is exemplified by the antenna shown in FIGS. 1 to 4, in which each switching unit 50 adopts the liquid crystal switch shown in FIG. 8. Referring to FIG. 2 that shows an X-directional linearly polarized antenna, a connection line between a center of the first feeding port 41 and a center of the second feeding port 42 is a first line segment, a connection line between a center of the third feeding port 43 and a center of the fourth feeding port 44 is a second line segment, and the first line segment and the second line segment are perpendicular to each other. The center of first feeding port 41, the center of the second feeding port 42, the center of the third feeding port 43 and the center of the fourth feeding port 44 each have a same distance (i.e., an identical distance), which is a first distance, from a center of the first waveguide structure 20. The first distance ranges from 3 mm to 8 mm, and is 5 mm in the present embodiment. The slow-wave dielectric layer is a PTFE plate, and has a thickness of 2.5 mm. The air gap has a thickness of 1.2 mm. The first dielectric substrate 10 has a thickness of 0.5 mm. Each slit opening has a length of 0.1 λg to 0.4 λg and a width of 0.001 λg to 0.04 λg, the control electrode 52 is 0.01 λg to 0.2 λg in length or in width, the liquid crystal layer 53 may have a thickness of 0.004 mm to 0.1 mm. In order to ensure single mode transmission in the first waveguide structure 20, the first waveguide structure 20 should have a height less than ½ λg, where λg is a wavelength of a wave in the first waveguide structure 20.

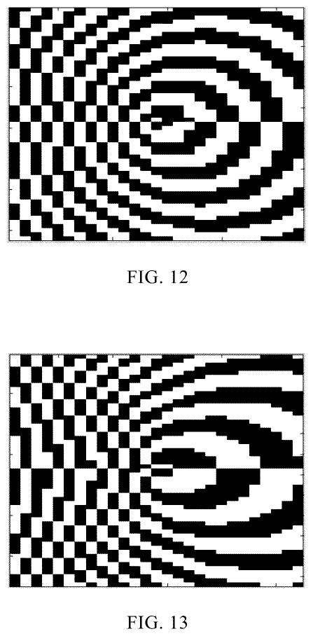

In an example of the present disclosure, a simulation may be performed at a frequency of 12 GHz. In this case, FIG. 11 is an actual topology diagram of the holographic leaky-wave antenna according to an embodiment of the present disclosure after binarization in a case of a beam pointing of φ₀=90° and θ₀=0°, where θ₀ is an elevation angle of the target beam pointing, and φ₀ is an azimuth angle of the target beam pointing. FIG. 12 is an actual topology diagram of the holographic leaky-wave antenna according to the present embodiment after binarization in a case of a beam pointing of φ₀=90° and θ₀=30°. FIG. 13 is the actual topology diagram of the holographic leaky-wave antenna according to the present embodiment after binarization in a case of a beam pointing of φ₀=90° and θ₀=60°.

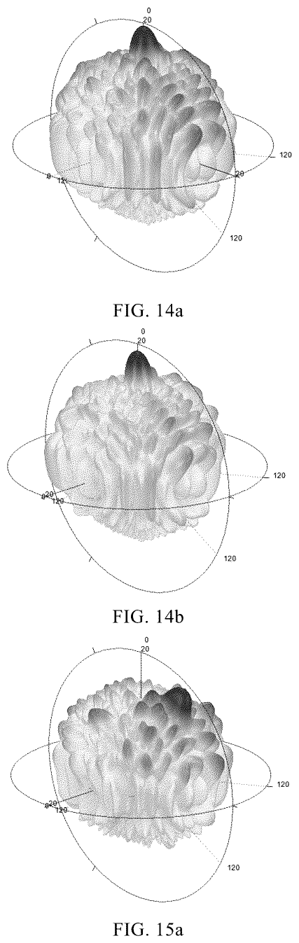

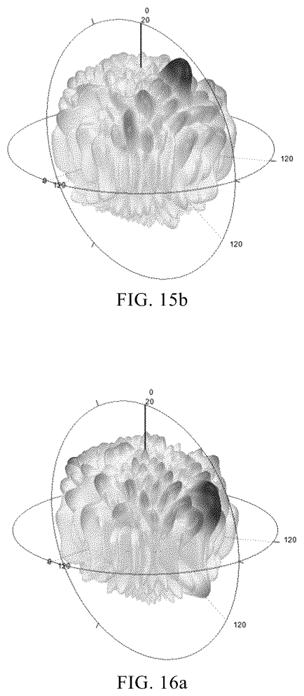

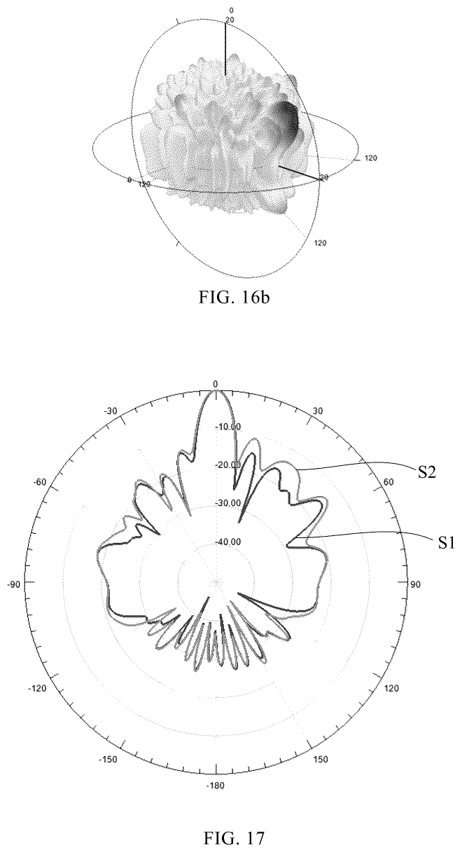

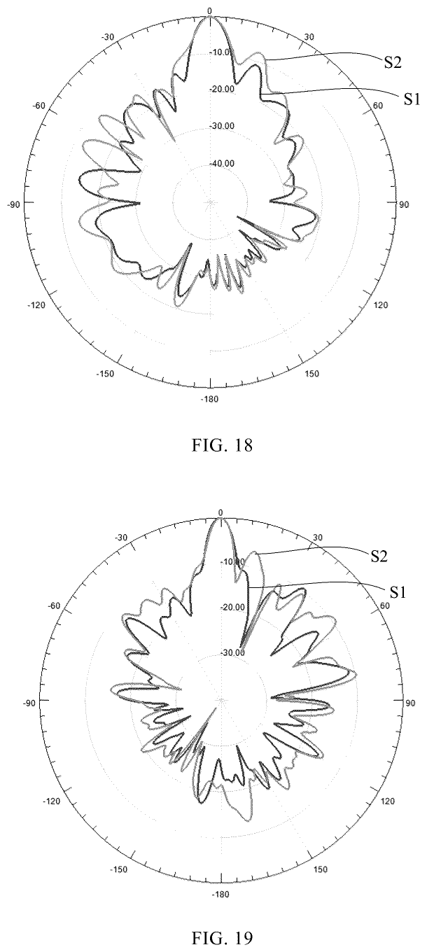

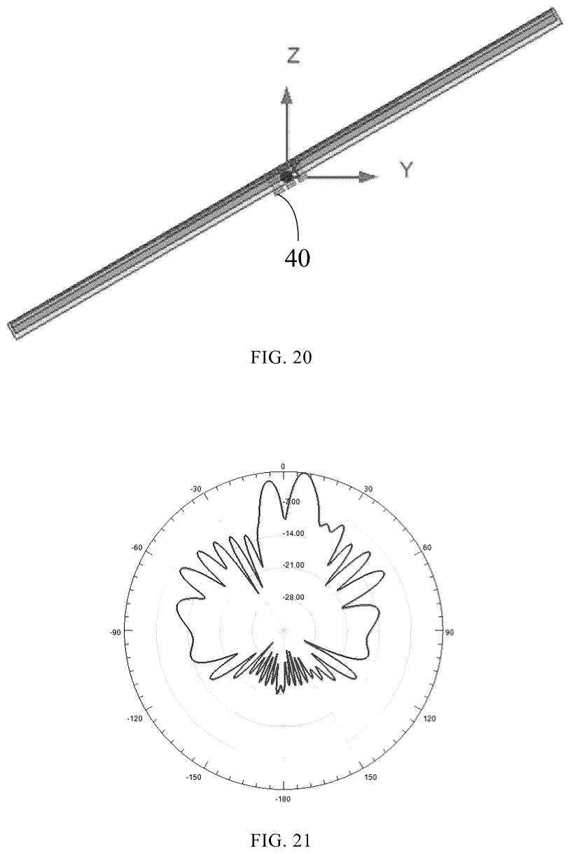

In the simulation carried out at the frequency of 12 GHz, FIG. 14a is a schematic directional pattern of a single point feeding in a case of a beam pointing of 0°, FIG. 14b is a schematic directional pattern of a four-point feeding in the case of the beam pointing of 0°, FIG. 15a is a schematic directional pattern of a single point feeding in a case of a beam pointing of 30°, FIG. 15b is a schematic directional pattern of a four-point feeding in the case of the beam pointing of 30°, FIG. 16a is a schematic directional pattern of a single point feeding in a case of a beam pointing of 60°, and FIG. 16b is a schematic directional pattern of a four-point feeding in the case of the beam pointing of 60°. As shown in FIGS. 14a, 14b, 15a, 15b, 16a and 16b, it can be clearly seen that the sidelobe values other than the main lobe of the directional pattern of the four-point feeding of the antenna are better than those of the single point feeding. FIG. 17 is a schematic normalized 2D directional pattern with poor sidelobes for a single point feeding and a four-point feeding in a case of a beam pointing of 0°. FIG. 18 is a schematic normalized 2D directional pattern with poor sidelobes for a single point feeding and a four-point feeding in a case of a beam pointing of 30°. FIG. 19 is a schematic normalized 2D directional pattern with poor sidelobes for a single point feeding and a four-point feeding in a case of a beam pointing of 60°. As shown in FIGS. 17-19, S1 represents the directional pattern for the four-point feeding, and S2 represents the directional pattern for the single point feeding. To cut the poor sidelobe values, the Z-axis is adjusted to coincide with a radiation angle of the antenna, as shown in FIG. 20 (which shows the radiation angle of 30°), so that the 2D directional patterns cut out are all directed at 0°.

In an embodiment of the present disclosure, the four-point feeding is adopted, so that the control of the holographic leaky-wave antenna can be more flexible. Further, by exciting phases of different amplitude with the probes, various different directional patterns of radiation of the antenna can be acquired, so that the antenna can be applied to different scenes more flexibly. For example, FIG. 21 is a schematic directional pattern of a middle depression of an equal-amplitude 90° phase-difference feeding achieved by the holographic leaky-wave antenna according to an embodiment of the present disclosure. As shown in FIG. 21, the directional pattern of the middle depression can be acquired by performing the equal-amplitude 90° phase-difference feeding on the four-point feeding.

The foregoing describes the holographic leaky-wave antenna according to the embodiments of the present disclosure that adopts one single-layer flat plate as the first waveguide structure 20.

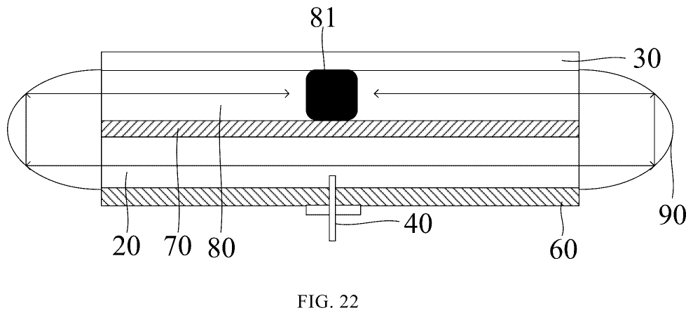

Alternatively, FIG. 22 is a schematic cross-sectional view of another holographic leaky-wave antenna according to some other embodiments of the present disclosure. As shown in FIG. 22, the holographic leaky-wave antenna in the present embodiment may have a double-layer parallel waveguide structure, i.e., include not only the first waveguide structure 20 described above, but also a second waveguide structure 80 disposed on a side of the radiation layer 30 proximal to the first waveguide structure 20, and a second reference electrode layer 70 disposed on a side of the second waveguide structure 80 proximal to the first waveguide structure 20.

Further, the antenna in the present example further includes a reflector member disposed at the periphery of the first waveguide structure 20 and the second waveguide structure 80. The reflector member 90 has a receiving space, at least the first waveguide structure 20, the second reference electrode layer 70 and the second waveguide structure 80 are disposed in the receiving space, and an electromagnetic wave transmitted through the first waveguide structure 20 is irradiated onto a sidewall of the reflector member 90 and then is reflected to the second waveguide structure 80 to be transmitted to the radiation layer 30. The first reference electrode layer 60 and the second reference electrode layer 70 each include, but are not limited to, a ground electrode layer. In the present embodiment, each of the first reference electrode layer 60 and the second reference electrode layer 70 is exemplified as a ground electrode.

Further, an absorbing load 81 is disposed in the second waveguide structure 80, and a center of the absorbing load 81 is located opposite to the center of the first reference electrode layer 60. The absorbing load 81 is configured to absorb the remaining guided waves, thereby preventing an electromagnetic wave from being reflected back into a waveguide feeding structure to interfere with the normal radiation of the antenna.

In a second aspect, an embodiment of the present disclosure provides an electronic device, which includes the holographic antenna according to any one of the foregoing embodiments. The antenna also includes a transceiver unit, a radio frequency transceiver, a signal amplifier, a power amplifier, and/or a filter unit. The antenna may serves as a transmitting antenna or a receiving antenna. The transceiver unit may include a baseband and a receiving terminal. The baseband provides signals of at least one frequency band, for example, provides 2G signals, 3G signals, 4G signals, 5G signals, and/or the like, and sends the signals of at least one frequency band to the radio frequency transceiver. After the signals are received by a transparent antenna in a communication system, the signals may be processed by the filter unit, the power amplifier, the signal amplifier, and the radio frequency transceiver (not shown in the figure), and then are transmitted to the receiving terminal of the transceiver unit. The receiving terminal may be, for example, an intelligent gateway.

Further, the radio frequency transceiver is connected to the transceiver unit, and is configured to modulate a signal sent by the transceiver unit or demodulate a signal received by the transparent antenna and then transmit the signal to the transceiver unit. Specifically, the radio frequency transceiver may include a transmitting circuit, a receiving circuit, a modulating circuit, and a demodulating circuit. After the transmitting circuit receives multiple types of signals provided by the baseband, the modulating circuit may modulate the multiple types of signals provided by the baseband, and then send the modulated signals to the antenna. The transparent antenna receives the signals and transmits the signals to the receiving circuit of the radio frequency transceiver, the receiving circuit transmits the signals to the demodulating circuit, and the demodulating circuit demodulates the signals and transmits the demodulated signals to the receiving terminal.

Further, the radio frequency transceiver is connected to the signal amplifier and the power amplifier, the signal amplifier and the power amplifier are further connected to the filter unit, and the filter unit is connected to at least one antenna. In the process of sending a signal by a communication system, the signal amplifier can improve the signal-to-noise ratio of the signal output by the radio frequency transceiver and then transmit the signal to the filter unit, the power amplifier can amplify the power of the signal output by the radio frequency transceiver and then transmit the signal to the filter unit, the filter unit specifically includes a duplexer and a filtering circuit, the filter unit combines the signal output by the signal amplifier and the signal output by the power amplifier, filters out noise waves from the combined signal, then transmits the signal to the transparent antenna, and the antenna radiates the signal out. In the process of receiving a signal by the communication system, the signal is received by the antenna, then is transmitted to the filter unit, the signal received by the antenna is filtered by the filter unit and then transmitted by the filter unit to the signal amplifier and the power amplifier; the signal received by the antenna are gained by the signal amplifier to increase the signal-to-noise ratio of the signal; and the power amplifier amplifies the power of the signal received by the antenna. The signal received by the antenna is processed by the power amplifier and the signal amplifier, then transmitted to the radio frequency transceiver, and the radio frequency transceiver transmits the signal to the transceiver unit.

In some examples, the signal amplifier may include various types of signal amplifiers, such as a low noise amplifier, but the present disclosure is not limited thereto.

In some examples, the antenna provided by an embodiment of the present disclosure further includes a power management unit, and the power management unit is connected to the power amplifier, to provide the power amplifier with a voltage for amplifying the signal.

It will be understood that the foregoing embodiments are merely exemplary embodiments adopted to illustrate the principles of the present disclosure, and the present disclosure is not limited thereto. It will be apparent to one of ordinary skill in the art that various modifications and improvements can be made therein without departing from the spirit and scope of the present disclosure, and such modifications and improvements are also considered to be within the scope of the present disclosure.

1. A holographic leaky-wave antenna, comprising:
a first waveguide structure,
a first dielectric substrate,
a radiation layer, and
a first reference electrode layer,
wherein the first dielectric substrate is arranged on the first waveguide structure and has a first gap with the first waveguide structure;
the first reference electrode layer is arranged on a side of the first waveguide structure distal to the first dielectric substrate;
the radiation layer is arranged on a side of the first dielectric substrate distal to the first waveguide structure, and has a plurality of slit openings therein; and
the holographic leaky-wave antenna further comprises a plurality of feeding ports configured on the first waveguide structure, and an orthogonal projection of each of the plurality of feeding ports on the first dielectric substrate does not overlap with an orthogonal projection of the first reference electrode layer on the first dielectric substrate.

2. The holographic leaky-wave antenna according to claim 1, further comprising a feeding structure configured to excite a microwave signal through the plurality of feeding ports.

3. The holographic leaky-wave antenna according to claim 2, wherein the feeding structure comprises a plurality of coaxial probes, each of which is installed at a position of one of the feeding ports.

4. The holographic leaky-wave antenna according to claim 2, wherein the feeding structure comprises SMA interfaces, each of which is installed at a position of one of the feeding ports.

5. The holographic leaky-wave antenna according to claim 1, wherein the plurality of feeding ports comprise four feeding ports.

6. The holographic leaky-wave antenna according to claim 1, wherein the plurality of feeding ports comprise four feeding ports which are a first feeding port, a second feeding port, a third feeding port, and a fourth feeding port, a connection line between a center of the first feeding port and a center of the second feeding port is a first line segment, a connection line between a center of the third feeding port and a center of the fourth feeding port is a second line segment, and the first line segment and the second line segment are perpendicular to each other.

7. The holographic leaky-wave antenna according to claim 6, wherein the center of first feeding port, the center of the second feeding port, the center of the third feeding port and the center of the fourth feeding port each have a same distance, which is a first distance, from a center of the first waveguide structure.

8. The holographic leaky-wave antenna according to claim 7, wherein the first distance ranges from 3 mm to 8 mm.

9. The holographic leaky-wave antenna according to claim 1, wherein the first waveguide structure comprises a slow-wave dielectric layer having the first gap with the first dielectric substrate.

10. The holographic leaky-wave antenna according to claim 9, further comprising a supporting member, wherein both ends of the supporting member abut against the slow-wave dielectric layer and the first dielectric substrate, respectively.

11. The holographic leaky-wave antenna according to claim 1, wherein the first gap has a thickness of 1.0 mm to 1.4 mm.

12. The holographic leaky-wave antenna according to claim 1, further comprising a second waveguide structure disposed on a side of the radiation layer proximal to the first waveguide structure, and a second reference electrode layer disposed on a side of the second waveguide structure proximal to the first waveguide structure.

13. The holographic leaky-wave antenna according to claim 12, further comprising an absorbing load disposed in the second waveguide structure.

14. The holographic leaky-wave antenna according to claim 1, further comprising a wave absorbing structure provided at a peripheral region of the first waveguide structure.

15. The holographic leaky-wave antenna according to claim 1, further comprising switching units provided on a side of the radiation layer distal to the first dielectric substrate, wherein the switching units are in one-to-one correspondence with the slit openings.

16. The holographic leaky-wave antenna according to claim 15, wherein each of the switching units comprises any one of a PIN diode, a variable reactance diode, a liquid crystal switch, or a MEMS switch.

17. The holographic leaky-wave antenna according to claim 1, wherein each of the slit openings has a length of 0.1 λg to 0.4 λg and a width of 0.001 λg to 0.04 λg, where λg is a wavelength of a wave in the first waveguide structure.

18. The holographic leaky-wave antenna according to claim 1, wherein the plurality of slit openings are arranged in an array or in a spiral shape.

19. The holographic leaky-wave antenna according to claim 1, wherein an outline of the radiation layer comprises a rectangle or a circle.

20. An electronic device, comprising the holographic leaky-wave antenna according to claim 1.
